(19) United States
(12) Patent Application Publication
(10) Pub. No.: US 2025/0336572 A1
(43) Pub. Date: Oct. 30, 2025

(54) ELECTRIC WIRE CUTTING EQUIPMENT AND SYNCHRONOUS WIRE SAW

(71) Applicant: CHANGZHOU CANTY ELECTRIC INDUSTRY CO., LTD, Changzhou (CN)

(72) Inventors: Jiazhong CHENG, Changzhou (CN); Wei CAO, Changzhou (CN)

(21) Appl. No.: 19/261,339

(22) Filed: Jul. 7, 2025

Related U.S. Application Data
(63) Continuation of application No. PCT/CN2024/098839, filed on Jun. 13, 2024.

(30) Foreign Application Priority Data
Nov. 10, 2023 (CN) 202323047879.9

(51) Int. Cl. H01B 13/00; B26D 1/46

(52) U.S. Cl. CPC H01B 13/0006; B26D 1/46

(57) ABSTRACT

An electric wire cutting equipment and a synchronous wire saw are provided. The electric wire cutting equipment includes a synchronization mechanism, a fixing frame, rotating wheels, a driving motor, and a cutting wire. The synchronization mechanism is arranged on the fixing frame. The rotating wheels include a driving wheel and a first driven wheel arranged opposite to each other on the synchronization mechanism. The driving wheel is transmission-connected to an output end of the driving motor. The cutting wire is wound between the driving wheel and the first driven wheel. The synchronization mechanism drives the cutting wire to move along the fixing frame. The synchronous wire saw includes a support frame and the electric wire cutting equipment rotationally connected to the fixing frame.

### CROSS-REFERENCE TO RELATED APPLICATIONS

This application is a US Continuation application of International Application No. PCT/CN2024/098839 filed on Jun. 13, 2024, which claims priority to Chinese Patent Application No. 202323047879.9 filed on Nov. 10, 2023. The aforementioned applications are herein incorporated by references in their entireties.

### TECHNICAL FIELD

The present disclosure relates to the field of wire cutting, and in particular, to an electric wire cutting equipment and a synchronous wire saw.

### BACKGROUND

As a commonly used cutting method in the field of cutting, electric wire cutting has unique cutting advantages, such as faster cutting efficiency and convenient operation, when cutting fiber modules and foam boards. However, structures where motors drive cutting wires in the current market generally have problems such as numerous components, complex structures, high manufacturing costs, and high requirements for the technical level of operators. In addition, in the market, there are also some equipment using individual motors to drive the cutting wires, but such equipment does not have a synchronous structure, so that the whole structure is relatively complex, with problems such as large volume, heavy weight, and difficult operation for ordinary users.

Therefore, there is an urgent need to provide an electric wire cutting equipment with a simple structure, convenient operation, and low manufacturing costs to solve above-described problems.

### SUMMARY

In a first aspect, the embodiments of the present disclosure provide an electric wire cutting equipment. The electric wire cutting equipment includes a synchronization mechanism, a fixing frame, rotating wheels, a driving motor, and a cutting wire.

The synchronous mechanism is arranged on the fixing frame. The rotating wheels include a driving wheel and a first driven wheel arranged opposite to each other on the synchronous mechanism. The driving wheel is transmission-connected to an output end of the driving motor. The cutting wire is wound between the driving wheel and the first driven wheel. The synchronization mechanism drives the cutting wire to move along the fixing frame.

In a second aspect, the embodiments of the present disclosure further provide a synchronous wire saw. The synchronous wire saw includes a support frame and the electric wire cutting equipment described in any one of the above-described embodiments. The support frame is rotationally connected to the fixing frame.

### BRIEF DESCRIPTION OF THE DRAWINGS

FIG. 1 is a first schematic view of a whole structure of an electric wire cutting equipment according to the embodiments of the present disclosure.

FIG. 2 is a second schematic view of a whole structure of an electric wire cutting equipment according to the embodiments of the present disclosure.

FIG. 3 is a schematic partial view of a structure of the electric wire cutting equipment according to the embodiments of the present disclosure.

FIG. 4 is an enlarged view of the electric wire cutting equipment at four places A, B, C, and D in FIG. 3 according to the embodiments of the present disclosure.

FIG. 5 is a first partial enlarged view of an electric wire cutting equipment according to the embodiments of the present disclosure.

FIG. 6 is a second partial enlarged view of an electric wire cutting equipment according to the embodiments of the present disclosure.

FIG. 7 is a schematic view of a whole structure of a synchronous wire saw according to the embodiments of the present disclosure.

FIG. 8 is a schematic view of a structure of a back side of a synchronous wire saw according to the embodiments of the present disclosure.

FIG. 9 is a schematic view of a folding structure of a support frame and an electric wire cutting equipment according to the embodiments of the present disclosure.

FIG. 10 is a first schematic view of an assembly structure of a support frame, an electric wire cutting equipment, and a rotating frame according to the embodiments of the present disclosure.

FIG. 11 is a second schematic view of an assembly structure of a support frame, an electric wire cutting equipment, and a rotating frame according to the embodiments of the present disclosure.

FIG. 12 is a schematic view of a folding structure of a support frame, an electric wire cutting equipment, and a rotating frame according to the embodiments of the present disclosure.

### DESCRIPTIONS OF REFERENCE NUMBERS ARE AS FOLLOWS

101, fixing frame; 102, dust-proof brush; 201, driving wheel, 202, first driven wheel; 203, second driven wheel; 204, third driven wheel; 301, driving motor; 4, synchronization mechanism; 401, first slider; 402, second slider; 403, first roller; 404, second roller; 405, third roller; 406, fourth roller; 407, fifth roller; 408, sixth roller; 409, transmission line; 410, sliding roller; 411, first connecting plate; 412, second connecting plate; 501, cutting wire; 502, tensioning mechanism;

6, support frame; 601, guiding groove; 602, connecting rod; 603, adjustable wrench; 604, scale; 605, main panel; 606, first adjusting ruler; 607, first arc-shaped groove; 608, first quick-lock handle;

7, rotating frame; 701, gap; 702, secondary panel; 703, second adjusting ruler; 704, second arc-shaped groove; 705, second quick-lock handle.

### DETAILED DESCRIPTION

In order to describe in detail the technical content, structural features, achieved objectives and effects of the technical solution, the following is described in detail with reference to specific embodiments and the accompanying drawings.

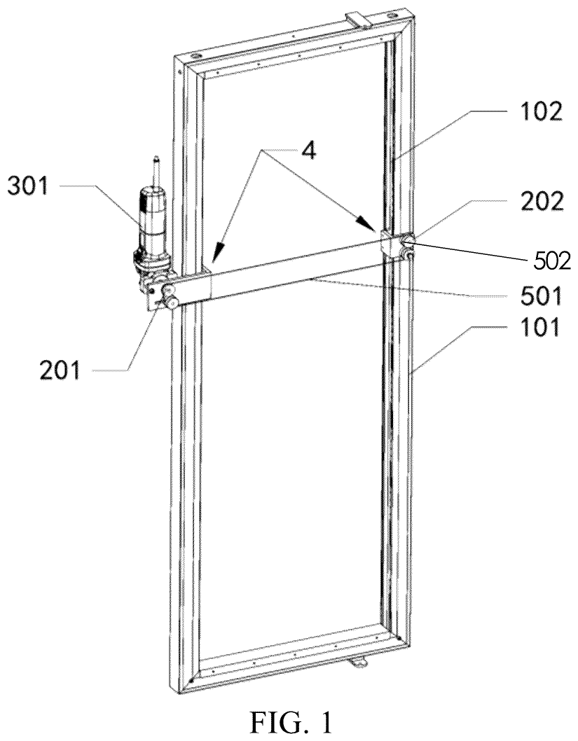

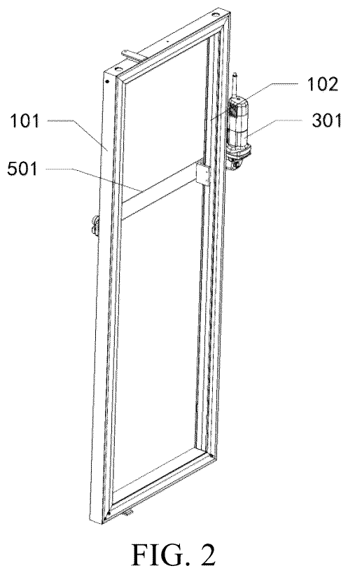

As shown in FIGS. 1 and 2, an electric wire cutting equipment is provided by the embodiments of the present disclosure. The electric wire cutting equipment includes a synchronization mechanism 4, a fixing frame 101, rotating wheels, a driving motor 301, and a cutting wire 501. The synchronization mechanism 4 is arranged on the fixing frame 101. The rotating wheels include a driving wheel 201 and a first driven wheel 202 arranged opposite to each other on the synchronization mechanism 4. The driving wheel 201 is transmission-connected to an output end of the driving motor 301. The cutting wire 501 is wound between the driving wheel 201 and the first driven wheel 202. The synchronization mechanism 4 drives the cutting wire 501 to move along the fixing frame 101.

As shown in FIGS. 1 to 3, in the embodiments of the present disclosure, an angle grinder is used as the driving motor 301. Certainly, in other embodiments, other types of motors can also be used as the driving motor 301. In the embodiments of the present disclosure, the angle grinder is used for easy holding. The angle grinder pushes the synchronization mechanism 4 to move along the fixing frame 101, so that the materials located below or above the cutting wire 501 are cut apart. In addition, in the embodiments of the present disclosure, the fixing frame 101 is a rectangular fixing frame. The synchronization mechanism 4 is disposed inside the rectangular fixing frame and moves up and down synchronously along frames at two sides of the rectangular fixing frame. In the embodiments of the present disclosure, the synchronization mechanism 4 is arranged within the frames which are two long sides of the rectangular fixing frame. In addition, a second driven wheel 203 is disposed on a side of the first driven wheel 202, e.g., the second driven wheel 203 is disposed above or below the first driven wheel 202. A third driven wheel 204 is disposed on a side of the driving wheel 201, e.g., the third driven wheel 204 is disposed above or below the driving wheel 201. The cutting wire 501 is wound around the driving wheel 201, the first driven wheel 202, the second driven wheel 203, and the third driven wheel 204. In the embodiments of the present disclosure, the cutting wire 501 is generally coated with emery. If a diameter of the driving wheel 201 or the driven wheel is smaller or a distance between two adjacent wheels is small, a bending angle of the cutting wire 501 will be relatively large. Thus the emery on the cutting wire 501 will easily fall off, the cutting effect is poor, the cutting wire needs to be frequently replaced, and the processing costs are increased. As such, in the embodiments of the present disclosure, a plurality of driven wheels are provided to effectively prolong the service life of the cutting wire 501.

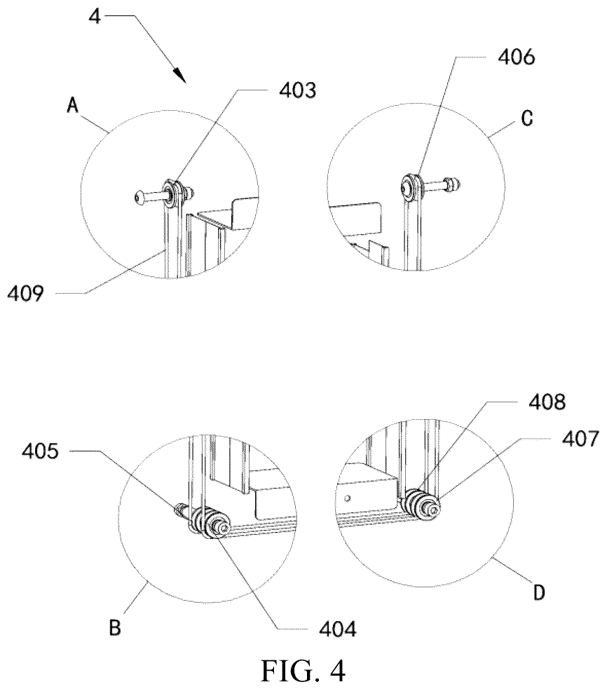

As shown in FIGS. 1 and 3 to 6, in the embodiments of the present disclosure, the synchronization mechanism 4 includes a first slider 401, a second slider 402, and a transmission line 409. The first slider 401 and the second slider 402 are respectively arranged opposite to each other on the fixing frame 101. The driving wheel 201 is connected to the first slider 401. The first driven wheel 202 is connected to the second slider 402. A first roller 403, a second roller 404, a third roller 405, a fourth roller 406, a fifth roller 407, a sixth roller 408 are disposed on the fixing frame 101. The first roller 403, and the second roller 404 and the third roller 405 are respectively arranged on two opposite sides of the first slider 401. The fourth roller 406, and the fifth roller 407 and the sixth roller 408 are respectively arranged on two opposite sides of the second slider 402. In the embodiments of the present disclosure, the first roller 403 is provided at one end of the fixing frame 101 above the first slider 401. The second roller 404 and the third roller 405 are provided at one end of the fixing frame 101 below the first slider 401. The fourth roller 406 is provided at one end of the fixing frame 101 above the second slider 402. The fifth roller 407 and the sixth roller 408 are provided at one end of the fixing frame 101 below the second slider 402. One end of the transmission line 409 is fixedly connected to the first slider 401. Then the transmission line 409 is wound around the first roller 403, the second roller 404, and the fifth roller 407 in sequence and fixedly connected to the second slider 402. Then the transmission line 409 is wound around the fourth roller 406, the sixth roller 408, and the third roller 405 in sequence and fixedly connected to the first slider 401. That is, during specific implementation process, when pushing the angle grinder or the synchronization mechanism 4, since the transmission line 409 is connected between the first slider 401 and the second slider 402, the first slider moves to drive the transmission line to move, the transmission line will drive the second slider to move synchronously, and the first slider 401 and the second slider 402 move along a same direction.

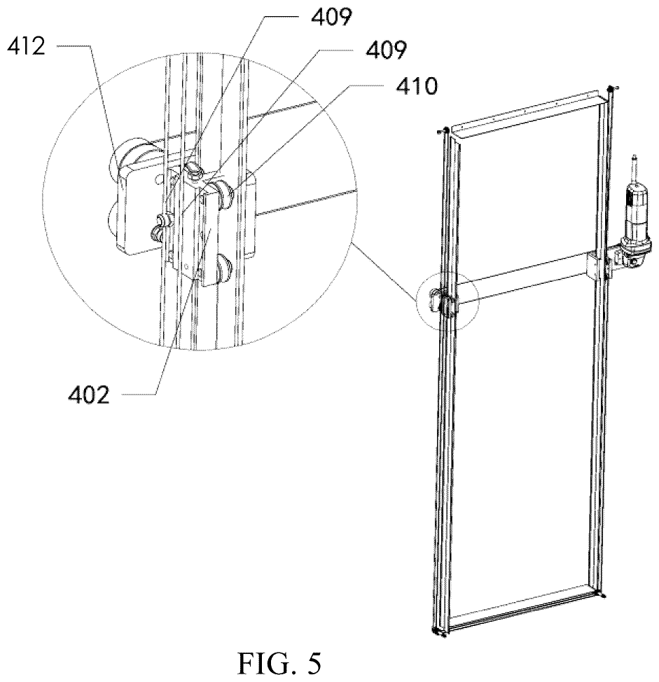

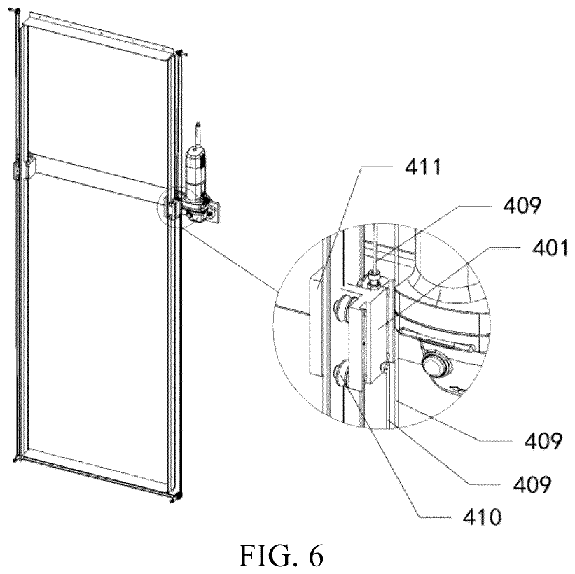

In some embodiments, as shown in FIGS. 5 and 6, in order to facilitate smoother movement of the first slider 401 and the second slider 402, the synchronization mechanism 4 includes the first slider 401 and the second slider 402. The first slider 401 and the second slider 402 are respectively arranged opposite to each other on the fixing frame 101. Sliding rollers 410 are disposed on the first slider 401 and the second slider 402, respectively. The sliding rollers 410 are slidably connected to the fixing frame 101.

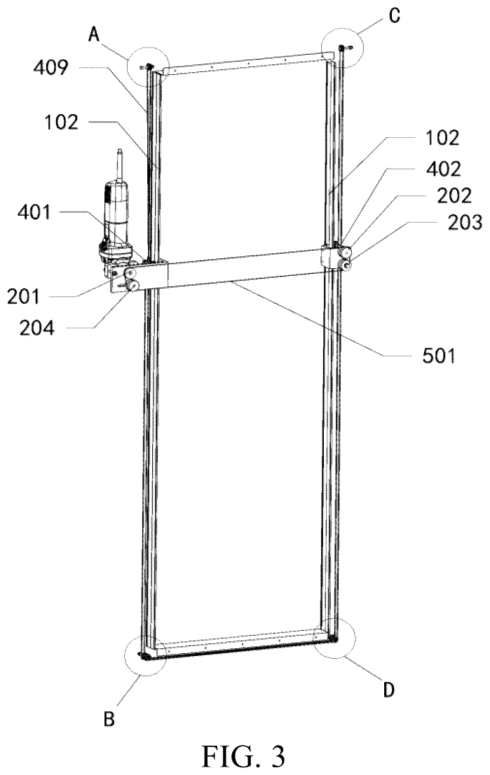

In some embodiments, in order to fix the driving motor or the angle grinder to improve the stability, as shown in FIGS. 3, 5, and 6, the synchronization mechanism 4 includes the first sliding block 401 and the second sliding block 402. The first sliding block 401 and the second sliding block 402 are respectively arranged opposite to each other on the fixing frame 101. An inner side of the fixing frame 101 along a movement direction of the synchronization mechanism 4 is provided a dust-proof brush 102. The first sliding block 401 and the second sliding block 402 are respectively provided with a connecting plate 411. The connecting plate 411 extends from the dust-proof brush 102. The driving wheel 201 is provided on the connecting plate 411 disposed on the first sliding block 401. The first driven wheel 202 is provided on the connecting plate 411 disposed on the second sliding block 402. In the embodiments of the present disclosure, a first connecting plate 411 is disposed on the first slider 401. A second connecting plate 412 is disposed on the second slider 402. The first connecting plate 411 and the second connecting plate 412 extend from the dust-proof brush 102, respectively. The driving wheel 201 is disposed on the first connecting plate 411. The first driven wheel 202 is disposed on the second connecting plate 412. In the embodiments of the present disclosure, the dust-proof brush 102 is provided to effectively prevent cutting debris from entering the fixing frame 101, which may cause the sliding of the first slider 401 and the second slider 402 to be blocked. In the embodiments of the present disclosure, the driving motor 301 is fixedly connected to the connecting plate disposed on the first slider 401.

In some embodiments, a tensioning mechanism 502 is further disposed at the first driven wheel 202, the second driven wheel 203, and/or the third driven wheel 204. The tensioning mechanism 502 can effectively provide a tensioning force for the cutting wire 501, so that the cutting wire 501 can cut more smoothly to prevent the cutting wire 501 from falling off from the driving wheel 201 and the driven wheel, causing safety risks caused by the high-speed rotating cutting wire 501.

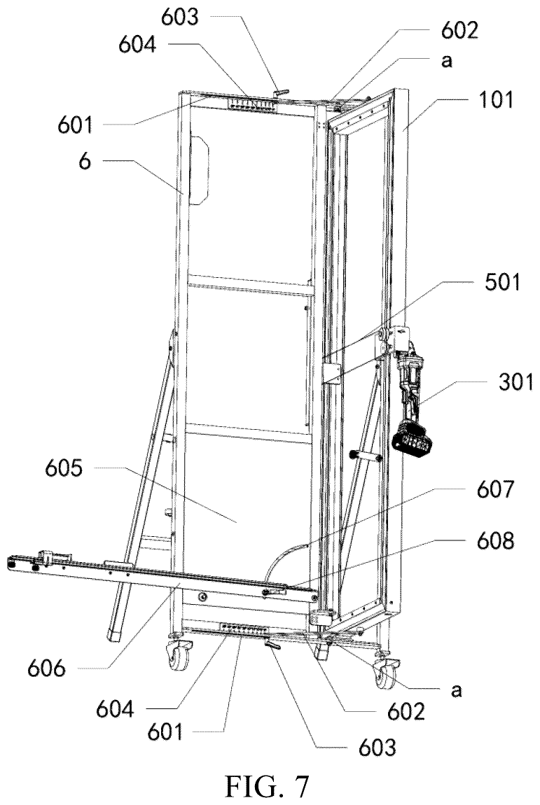

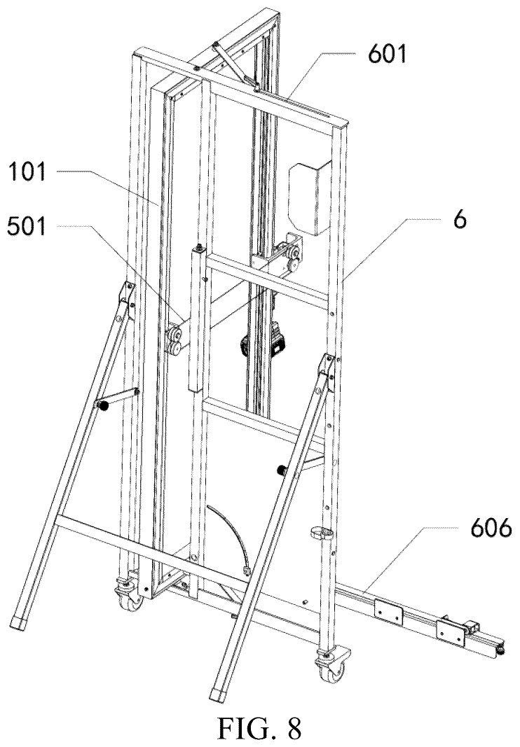

As shown in FIGS. 7 and 8, a synchronous wire saw is provided by the embodiments of the present disclosure. The synchronous wire saw includes the electric wire cutting equipment and a support frame 6.

The electric wire cutting equipment includes a synchronization mechanism 4, a fixing frame 101, rotating wheels, a driving motor 301, and a cutting wire 501. The synchronization mechanism 4 is arranged along the fixing frame 101. The rotating wheels include a driving wheel 201 and a first driven wheel 202 arranged opposite to each other on the synchronization mechanism 4. The driving wheel 201 is transmission-connected to an output end of the driving motor 301. The cutting wire 501 is wound between the driving wheel 201 and the first driven wheel 202. The synchronization mechanism 4 drives the cutting wire 501 to move along the fixing frame 101. The support frame 6 is rotationally connected to the fixing frame 101, and a rotation point is shown as point a in FIG. 1.

In some embodiments of the present disclosure, in order to cut an inclined plane for the materials, as shown in FIGS. 7 and 8, a top and/or a bottom of the support frame 6 is provided a guiding groove 601, a top and/or a bottom of the fixing frame 101 is provided with a connecting rod 602 for rotation, i.e., one end of the connecting rod 602 is rotationally connected to the fixing frame 101, and another end of the connecting rod 602 is slidably connected to the guiding groove 601. In the embodiments of the present disclosure, during the specific implementation processes, when the materials need to be performed inclined plane cutting, an angle between the fixing frame 101 and the support frame 6 is adjusted by adjusting a position of one end of the connecting rod 602 located in the guiding groove 601, i.e., by adjusting one end of the connecting rod 602 connected to the guiding groove 601. Since the cutting wire 5501 moves and cuts along the fixing frame 101 driven by the driving motor 301, the materials will be cut into the inclined plane.

In order to adjust the position of the connecting rod 602 inside the guiding groove 601, in the embodiments of the present disclosure, an end of the connecting rod 602 located at one end of the guiding groove 601 is provided with an adjustable wrench 603, i.e., the end of the connecting rod 602 connected to the guiding groove 601 is provided with an adjustable wrench 603. The position can be adjusted quickly and conveniently through the adjustable wrench 603. In addition, the support frame 101 on one side of the guiding groove 601 is provided with a scale 604. The scale 604 is an angle scale for measuring an angle between the fixing frame 101 and the support frame 6, i.e., for determining a size of the inclined plane cut by the cutting wire 501 on the materials.

In addition, as shown in FIG. 7, in some embodiments of the present disclosure, a main panel 605 is provided on the support frame 6 located on one side of the fixing frame 101. A first adjusting ruler 606 is provided on the main panel 605. One end of the first adjusting ruler 606 close to the fixing frame 101 is rotationally connected to the main panel 605 or support frame 6. In the embodiments of the present disclosure, the main panel 605 is provided to facilitate the attachment of the materials to the main panel 605. A bottom of the materials can be placed or clamped on the first adjusting ruler 606. The first adjusting ruler 606 is provided to adjust whether an edge of the material to be cut is a straight edge or an inclined edge. When the first adjusting ruler 606 is adjusted to a non-horizontal position, one end of the materials cut by the cutting wire 501 is the inclined edge. Specifically, in the embodiments of the present disclosure, a first arc-shaped groove 607 is provided on the main panel 605 with a rotation point of the first adjusting ruler 606 as center. The first adjusting ruler 606 is connected to the first arc-shaped groove 607 through a first quick-lock handle 608.

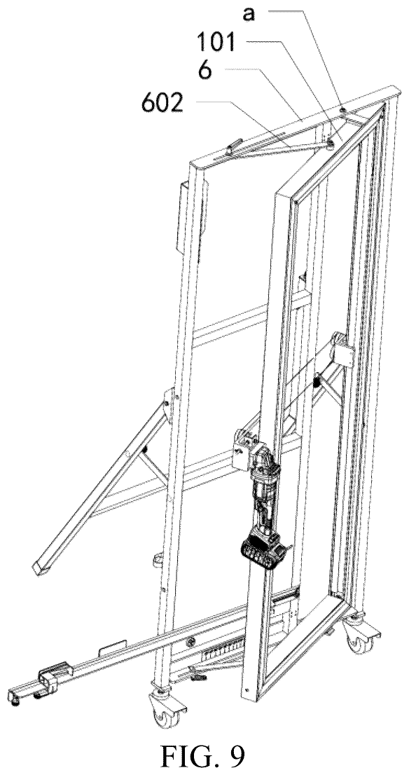

As shown in FIG. 9, when the synchronous wire saw needs to be carried and transported, the support frame 6 and the electric wire cutting equipment need to be folded. Under this case, the first adjustment rule 606 can be adjusted from a horizontal state to a state perpendicular or inclined to the horizontal plane, so that the first adjustment rule 606 can be on the panel where the support frame 6 is located. Then the adjustable wrench is loosened, and the fixing frame 101 is rotated using point a as the rotation point until the fixing frame 101 fits the support frame 6. Then the support legs behind the support frame 6 are retracted, and the synchronous wire saw can be carried and transported. Thus a volume of the synchronous wire saw is relatively small and easy to be carried and transported.

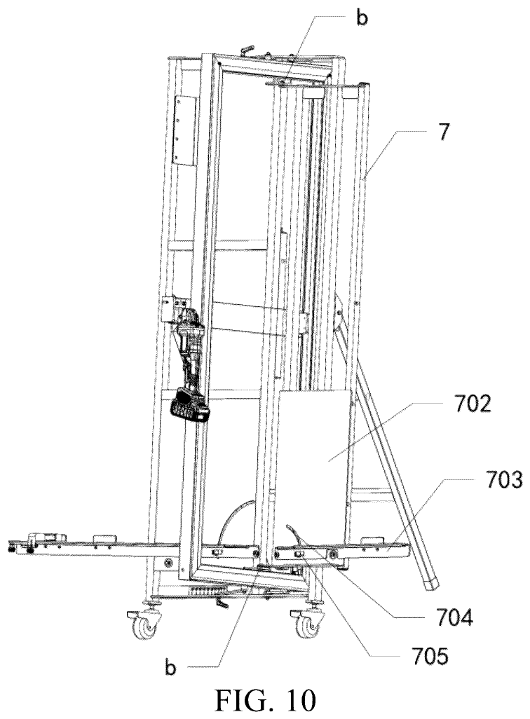

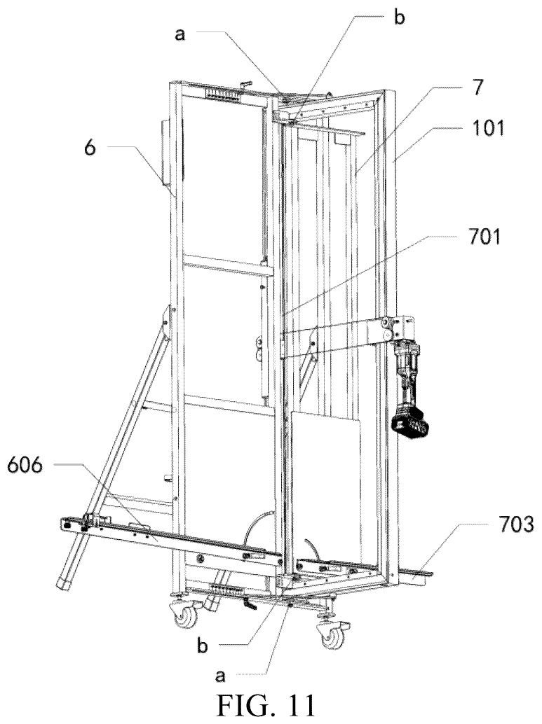

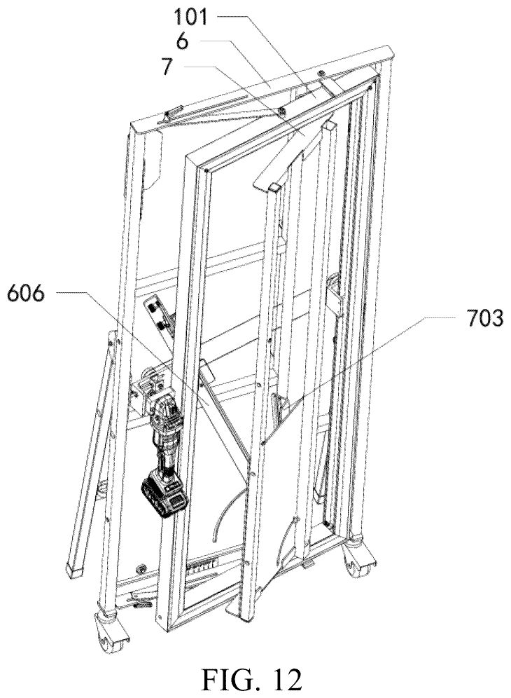

In some embodiments of the present disclosure, as shown in FIGS. 10, 11, and 12, the synchronous wire saw further includes a rotating frame 7. The rotating frame 7 is disposed on another side of the fixing frame 101 away from the main panel 605. One side of the rotating frame 7 close to the fixing frame 101 is rotationally connected to the support frame 6 with point b as a rotation point. A gap 701 is provided between the side where the rotating frame 7 is rotationally connected to the support frame 6 and the main panel 605. The cutting wire 501 performs reciprocating cutting motion along the gap 701. In the embodiments, the rotating frame 7 is provided to facilitate the placement and cutting of the materials. In the embodiments of the present disclosure, a secondary panel 702 is disposed on the rotating frame 7. A second adjusting ruler 703 is disposed on the secondary panel 702. One end of the second adjusting ruler 703 close to the fixing frame 101 is rotationally connected to the secondary panel 702 or the support frame 6. The secondary panel 702 is provided with a second arc-shaped groove 704 with the rotation point of the second adjusting ruler 703 as center. The second adjusting ruler 703 is connected to the second arc-shaped groove 704 through a second quick-lock handle 705. In the embodiments of the present disclosure, the secondary panel 702 is provided to facilitate the placement of the materials. When the materials are cut, a side surface of the materials can be attached to the secondary panel 702. A bottom of the secondary panel 702 can be placed on the second adjusting ruler 703. Whether the edge cut by the materials is the straight edge or the inclined edge can be adjusted through the second adjusting ruler 703.

Beneficial effects of the embodiments of the present disclosure are illustrated as follows.

In the electric wire cutting equipment, the synchronization mechanism is provided to drive the cutting wire to move synchronously along the fixing frame, and the driving motor drives the cutting wire to move circularly, thereby effectively realizing the wire cutting for the materials. A structure of the equipment is simple, only the driving motor of the whole equipment has a certain weight, and other structures are light, so that the equipment is lightweight to be easy to hold and operate. Moreover, the equipment has low manufacturing costs, thereby having broad application prospects.

In the synchronous wire saw, the synchronization mechanism is provided to drive the cutting wire to move synchronously along the fixing frame, and the driving motor drives the cutting wire to move circularly, thereby effectively realizing the wire cutting for the materials. In addition, the support frame is provided to effectively provide a support force to the electric wire cutting equipment. When the synchronous wire saw is working, it is only necessary to install the electric wire cutting equipment on the support frame. After placing the materials, the driving motor starts to move along the fixing frame to achieve wire cutting operations. A structure of the synchronous wire saw is simple. The equipment has broad application prospects due to lightweight, easy to operate, and low manufacturing costs.

It should be noted that although the above-described embodiments have been described herein, the scope of patent protection of the present disclosure is not limited thereby. Therefore, based on the innovative concept of the present disclosure, changes and modifications to the embodiments described herein, or equivalent structural or equivalent process changes made using the contents of the present disclosure and the contents of the present disclosure, directly or indirectly applying the above technical solutions to other related technical fields are included in the patent protection scope of the present disclosure.

What is claimed is:

1. An electric wire cutting equipment, comprising:
a fixing frame;
a synchronization mechanism arranged on the fixing frame;
rotating wheels comprising a driving wheel and a first driven wheel arranged opposite to each other on the synchronization mechanism;
a driving motor, wherein the driving wheel is transmission-connected to an output end of the driving motor; and
a cutting wire wound between the driving wheel and the first driven wheel;
wherein the synchronization mechanism drives the cutting wire to move along the fixing frame.

2. The electric wire cutting equipment according to claim 1, wherein the synchronization mechanism comprises a first slider, a second slider, and a transmission line, the first slider and the second slider are respectively arranged opposite to each other on the fixing frame, the driving wheel is connected to the first slider, the first driven wheel is connected to the second slider, wherein a first roller, a second roller, a third roller, a fourth roller, a fifth roller, and a sixth roller are disposed on the fixing frame, wherein the first roller, and the second roller and the third roller are respectively arranged on two opposite sides of the first slider, wherein the fourth roller, and the fifth roller and the sixth roller are respectively arranged on two opposite sides of the second slider, and wherein the transmission line is wound around the first roller, the second roller, the fifth roller, the fourth roller, the sixth roller, and the third roller in sequence, and is fixedly connected to the first slider and the second slider.

3. The electric wire cutting equipment according to claim 2, wherein the first slider and the second slider are respectively provided with sliding rollers, and the sliding rollers are slidably connected to the fixing frame.

4. The electric wire cutting equipment according to claim 2, wherein an inner side of the fixing frame along a movement direction of the synchronization mechanism is provided with a dust-proof brush, a first connecting plate is disposed on the first slider, a second connecting plate is disposed on the second slider, the first connecting plate and the second connecting plate extend from the dust-proof brush, respectively, the driving wheel is disposed on the first connecting plate, and the first driven wheel is disposed on the second connecting plate.

5. The electric wire cutting equipment according to claim 4, wherein the driving motor is fixedly connected to the first connecting plate.

6. The electric wire cutting equipment according to claim 1, wherein a second driven wheel is disposed on a side of the first driven wheel, and a third driven wheel is disposed on a side of the driving wheel, the cutting wire is wound around the driving wheel, the first driven wheel, the second driven wheel, and the third driven wheel.

7. The electric wire cutting equipment according to claim 6, further comprising a tensioning mechanism provided at the first driven wheel, the second driven wheel, and/or the third driven wheel.

8. The electric wire cutting equipment according to claim 1, wherein the driving motor comprises an angle grinder.

9. The electric wire cutting equipment according to claim 1, wherein the fixing frame is a rectangular fixing frame, and the synchronization mechanism is disposed inside the rectangular fixing frame and moves synchronously and circularly along frames on two sides of the rectangular fixing frame.

10. A synchronous wire saw, comprising a support frame and an electric wire cutting equipment, wherein the electric wire cutting equipment comprises:
a fixing frame;
a synchronization mechanism arranged on the fixing frame;
rotating wheels comprising a driving wheel and a first driven wheel arranged opposite to each other on the synchronization mechanism;
a driving motor, wherein the driving wheel is transmission-connected to an output end of the driving motor; and
a cutting wire wound between the driving wheel and the first driven wheel;
wherein the synchronization mechanism drives the cutting wire to move along the fixing frame, and the support frame is rotationally connected to the fixing frame.

11. The synchronous wire saw according to claim 10, wherein a top and/or a bottom of the support frame is provided with a guiding groove, a top and/or a bottom of the fixing frame is provided with a connecting rod, one end of the connecting rod is rotationally connected to the fixing frame, and another end of the connecting rod is slidably connected to the guiding groove.

12. The synchronous wire saw according to claim 11, wherein the end of the connecting rod connected to the guiding groove is provided with an adjustable wrench, and the support frame is provided with a scale on one side of the guiding groove.

13. The synchronous wire saw according to claim 10, wherein the support frame close to the fixing frame is provided with a main panel, a first adjusting ruler is disposed on the main panel, one end of the first adjusting ruler close to the fixing frame is rotationally connected to the main panel or the support frame, the main panel is provided with a first arc-shaped groove with a rotation point of the first adjusting ruler as center, and the first adjusting ruler is connected to the first arc-shaped groove through a first quick-lock handle.

14. The synchronous wire saw according to claim 13, further comprising a rotating frame disposed on another side of the fixing frame away from the main panel, one side of the rotating frame close to the fixing frame is rotationally connected to the support frame, a gap is provided between the main panel and the side of the rotating frame rotationally connected to the support frame, and the cutting wire performs a reciprocating cutting motion along the gap.

15. The synchronous wire saw according to claim 14, wherein the rotating frame is provided with a secondary panel, the secondary panel is provided with a second adjusting ruler, one end of the second adjusting ruler close to the fixing frame is rotationally connected to the secondary panel or the support frame, the secondary panel is provided with a second arc-shaped groove with a rotation point of the second adjusting ruler as center, and the second adjusting ruler is connected to the second arc-shaped groove through a second quick-lock handle.

16. The synchronous wire saw according to claim 10, wherein the synchronization mechanism comprises a first slider, a second slider, and a transmission line, the first slider and the second slider are respectively arranged opposite to each other on the fixing frame, the driving wheel is connected to the first slider, the first driven wheel is connected to the second slider, wherein a first roller, a second roller, a third roller, a fourth roller, a fifth roller, and a sixth roller are disposed on the fixing frame, wherein the first roller, and the second roller and the third roller are respectively arranged on two opposite sides of the first slider, wherein the fourth roller, and the fifth roller and the sixth roller are respectively arranged on two opposite sides of the second slider, and wherein the transmission line is wound around the first roller, the second roller, the fifth roller, the fourth roller, the sixth roller, and the third roller in sequence, and is fixedly connected to the first slider and the second slider

17. The synchronous wire saw according to claim 16, wherein the synchronization mechanism comprises a first slider and a second slider respectively arranged opposite to each other on the fixing frame, the first slider and the second slider are respectively provided with sliding rollers, and the sliding rollers are slidably connected to the fixing frame.

18. The synchronous wire saw according to claim 16, wherein an inner side of the fixing frame along a movement direction of the synchronization mechanism is provided with a dust-proof brush, a first connecting plate is disposed on the first slider, a second connecting plate is disposed on the second slider, the first connecting plate and the second connecting plate extend from the dust-proof brush, respectively, the driving wheel is disposed on the first connecting plate, and the first driven wheel is disposed on the second connecting plate.

19. The synchronous wire saw according to claim 18, wherein the driving motor is fixedly connected to the first connecting plate disposed on the first slider.

20. The synchronous wire saw according to claim 10, wherein a second driven wheel is disposed on a side of the first driven wheel, and a third driven wheel is disposed on a side of the driving wheel, the cutting wire is wound around the driving wheel, the first driven wheel, the second driven wheel, and the third driven wheel.
